(19) United States
(12) Patent Application Publication
(10) Pub. No.: US 2010/0218122 A1
(43) Pub. Date: Aug. 26, 2010

(54) ASYNCHRONOUSLY UPLOADING AND RESIZING CONTENT IN WEB-BASED APPLICATIONS

(75) Inventors: Nicholas Allen Robarge, Redmond, WA (US); Jeffrey D. Chi, Bellevue, WA (US); Daniel Albert Swett, Issaquah, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/389,377

(22) Filed: Feb. 20, 2009

(51) Int. Cl. G06F 3/00

(52) U.S. Cl. 715/760

(57) ABSTRACT

Tools and techniques are provided for asynchronously uploading and resizing content in web-based applications. These tools may deploy instances of the web-based applications within browser components installed on client systems. The tools may also at least begin uploads of content from the client systems, and send upload activity graphics for rendering within the browser while the content is uploading from the client systems. In addition, the tools enable users to interact with the client systems while the content is being uploaded from those client systems.

### BACKGROUND

Traditionally, software was deployed on a stand-alone basis to individual physical machines or workstations. For example, if a given user wished to use a word processor on his or her machine, he or she would install the word processor software on that machine. However, web-based applications are gaining increased acceptance within the industry. Web-based applications typically operate on a client-server model, with the application software installed on a centralized server and accessible to any number of client machines. The client machines typically include browser software, through which users may navigate to the server hosting the Web-based applications. Through the browser software, users accessing local client systems may execute the application software that is hosted on the server, even though that application software is not physically installed on the local client systems.

### SUMMARY

Tools and techniques are provided for asynchronously uploading and resizing content in web-based applications. These tools may deploy instances of the web-based applications within browser components installed on client systems. The tools may also at least begin uploads of content from the client systems, and send upload activity graphics for rendering within the browser while the content is uploading from the client systems. In addition, the tools enable users to interact with the client systems while the content is being uploaded from those client systems.

It should be appreciated that the above-described subject matter may be implemented as a computer-controlled apparatus, a computer process, a computing system, or as an article of manufacture such as a computer-readable medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a combined block and flow diagram illustrating systems or operating environments suitable for asynchronously uploading and resizing content in web-based applications.

FIG. 2 is a flow diagram illustrating processes for asynchronously uploading content to a server system.

FIG. 3 is a flow diagram that continues the illustration of the asynchronous uploading processes shown in FIG. 2.

FIG. 4 is a flow diagram illustrating processes for asynchronously resizing content uploaded to a server system.

FIG. 5 is a flow diagram that continues the illustration of the asynchronous resizing processes shown in FIG. 4.

FIG. 6 is a block diagram illustrating example user interfaces (UIs) suitable for uploading content from a client system to a server system.

FIG. 7 is a block diagram illustrating additional features of the UIs as shown in FIG. 6, namely UI tools to present a selection of files available for uploading.

FIG. 8 is a block diagram illustrating additional features of the UIs as shown in FIG. 6, namely UI tools to select an available file for uploading.

FIG. 9 is a block diagram illustrating additional features of the UIs as shown in FIG. 6, namely illustrating an upload activity graphic that serves as a placeholder, presented with an insertion point or cursor in the UI.

FIG. 10 is a block diagram illustrating additional features of the UIs as shown in FIG. 6, namely illustrating sample text presented with the upload activity graphic.

FIG. 11 is a block diagram illustrating additional features of the UIs as shown in FIG. 6, namely illustrating uploaded content replacing the upload activity graphic in the UI.

FIG. 12 is a block diagram illustrating additional features of the UIs as shown in FIG. 6, namely illustrating the uploaded content in a selected mode, along with a set of content resizing tools.

FIG. 13 is a block diagram illustrating additional features of the UIs as shown in FIG. 6, namely illustrating the uploaded content as resized preliminarily, in response to a content resizing command issued using the content resizing tools.

FIG. 14 is a block diagram illustrating additional features of the UIs as shown in FIG. 6, namely illustrating the uploaded content as completely resized, in response to the content resizing command.

### DETAILED DESCRIPTION

The following detailed description provides tools and techniques for asynchronously uploading and resizing content in web-based applications. While the subject matter described herein presents a general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

The following detailed description refers to the accompanying drawings that form a part hereof, and that show, by way of illustration, specific example implementations. Referring now to the drawings, in which like numerals represent like elements through the several figures, this description provides various tools and techniques for asynchronously uploading and resizing content in web-based applications.

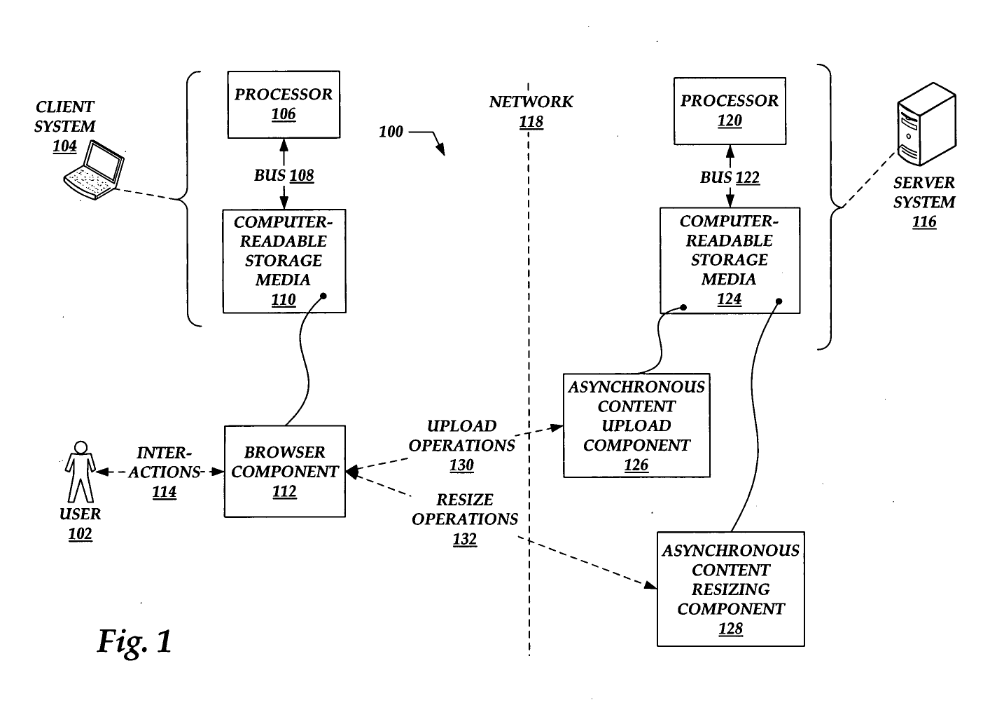

FIG. 1 illustrates systems or operating environments, denoted generally at 100, suitable for asynchronously uploading and resizing content in web-based applications. Turning to FIG. 1 in more detail, any number of users 102 may interact with corresponding client systems 104. The client systems 104 may represent relatively stationary desktop computing systems, more mobile laptop or notebook-type computing systems, as well as other examples not shown in FIG. 1 in the interest of clarity. For example, these other examples may include smartphones, cellular telephones, wireless communications devices, and the like.

Turning to the client systems 104 in more detail, these client systems may include one or more processors 106, which may have a particular type or architecture, chosen as appropriate for particular implementations. The processors 106 may couple to one or more bus systems 108, having type and/or architecture that is chosen for compatibility with the processors 106.

The client systems 104 may also include one or more instances of computer-readable storage medium or media 110, which couple to the bus systems 108. The bus systems 110 may enable the processors 106 to read code and/or data to/from the computer-readable storage media 110. The media 110 may represent apparatus in the form of storage elements that are implemented using any suitable technology, including but not limited to semiconductors, magnetic materials, optics, or the like. The media 110 may include memory components, whether classified as RAM, ROM, flash, or other types, and may also represent hard disk drives.

The storage media 110 may include one or more modules of instructions that, when loaded into the processor 106 and executed, cause the client systems 104 to perform various techniques related to asynchronously uploading and resizing content in web-based applications. As detailed throughout this description, these modules of instructions may also provide various tools or techniques by which the client systems 104 may provide for asynchronously uploading and resizing content in web-based applications using the components, flows, and data structures discussed in more detail throughout this description. For example, the storage media 110 may include one or more software modules that implement browser software or browser components 112. In general, the browser software 112 as shown in FIG. 1 may also represent other types of thin-client software.

In general, the users 102 may interact with the client systems 104, or more specifically with the browser components 112. FIG. 1 generally represents these interactions at 114, with these interactions including, but not limited to, commands issued by the users 102, data provided by those users 102, as well as any outputs provided to those users 102 by the client systems 104.

In some implementations, the systems or operating environments 100 may include one or more server systems 116. The server systems 116 may be operatively in figure to communicate with any number of client systems 104. It is noted that FIG. 1 illustrates one example of the client system 104 and the server system 116 only for clarity of illustration, but not to limit possible implementations of this description. For example, such implementations may include any number of client systems 104 and server systems 116. In addition, this description may refer to the client systems 104 and server systems 116 as sub-systems, depending on context.

In some implementations, the systems or operating environments 100 may include one or more intermediate communications networks 118. Turning to the networks 118 in more detail, these networks 118 may represent any number of communications networks. For example, the networks 118 may represent local area networks (LANs), wide area networks (WANs), and/or personal area networks (e.g., Bluetooth-type networks), any of which may operate alone or in combination to facilitate operation of the tools and techniques provided in this description. The networks 118 as shown in FIG. 1 also represents any hardware (e.g., adapters, interfaces, cables, and the like), software, or firmware associated with implementing these networks, and may also represent any protocols by which these networks may operate.

The graphical representations of the server systems 116 and the client systems 104 as presented in FIG. 1 are chosen only for convenience of illustration, but not to limit possible implementations. For example, suitable hardware environments may also include, but are not limited to: relatively stationary desktop computing systems; laptop notebook, or other relatively mobile computing systems; wireless communications devices, such as cellular phones, smartphones, wireless-enabled personal digital assistants (PDAs); or other similar communications devices. In addition, the tools and techniques described herein for indexing and querying data stores using concatenated terms may be implemented with hardware environments other than those shown in FIG. 1, without departing from the scope and spirit of the present description.

Turning to the server systems 116 in more detail, these server systems may include one or more processors 120, which may have a particular type or architecture, chosen as appropriate for particular implementations. The processors 120 may couple to one or more bus systems 122, having type and/or architecture that is chosen for compatibility with the processors 120. It is noted that the processors 120 and bus systems 122 in the server systems 116 may or may not be of the same type and architecture as the processors 106 and bus systems 108 in the client systems 104.

The server systems 116 may also include one or more instances of computer-readable storage medium or media 124, which couple to the bus systems 122. The bus systems 122 may enable the processors 120 to read code and/or data to/from the computer-readable storage media 124. The media 124 may represent apparatus in the form of storage elements that are implemented using any suitable technology, including but not limited to semiconductors, magnetic materials, optics, or the like. The media 124 may include memory components, whether classified as RAM, ROM, flash, or other types, and may also represent hard disk drives.

The storage media 124 may include one or more modules of instructions that, when loaded into the processor 120 and executed, cause the server systems 116 perform various techniques related to asynchronously uploading and resizing content in web-based applications. As detailed throughout this description, these modules of instructions may also provide various tools or techniques by which the server systems 116 may provide for asynchronously uploading and resizing content in web-based applications using the components, flows, and data structures discussed in more detail throughout this description. For example, the storage media 124 may include one or more software modules that implement components 126 for asynchronously uploading content from the client systems 104, as well as components 128 for asynchronously resizing content.

In the examples shown in FIG. 1, the client systems 104 and server systems 116 may enable users 102 to upload content to the server systems 116. FIG. 1 generally represents at 130 any operations or workflows related to uploading this content. More specifically, the operations 130 may include any bidirectional command and/or data flows related to uploading this content from the client systems 104 to the server systems 116. In addition, this content is described herein as being uploaded “asynchronously”, in the sense that this upload may continue in the background on the client systems 104, without otherwise interrupting any workflows occurring on the client systems 104. These asynchronous upload operations 130 are described in further detail below, while elaborating further on the software components 126 for asynchronously uploading the content.

Similarly, the client systems 104 and server systems 116 may enable the users 102 to resize certain content presented within the browser components 112. More specifically, the users 102 may interact with the software components 128 asynchronously to resize this content. FIG. 1 generally represents at 132 any operations or workflows related to resizing this content, along with any data and/or command flows related to generating this resized content.

In general, the asynchronous upload components 126 and the asynchronous resizing components 128 as installed on the server systems 116 may send instructions to the browser components 112 in any suitable form (e.g., JavaScript™ or any other languages, whether scripting or otherwise). In this manner, the server systems 116, or more specifically, the asynchronous upload components 126 and the asynchronous resizing components 128, may cause the browser components 112 to perform the various functions provided in this description.

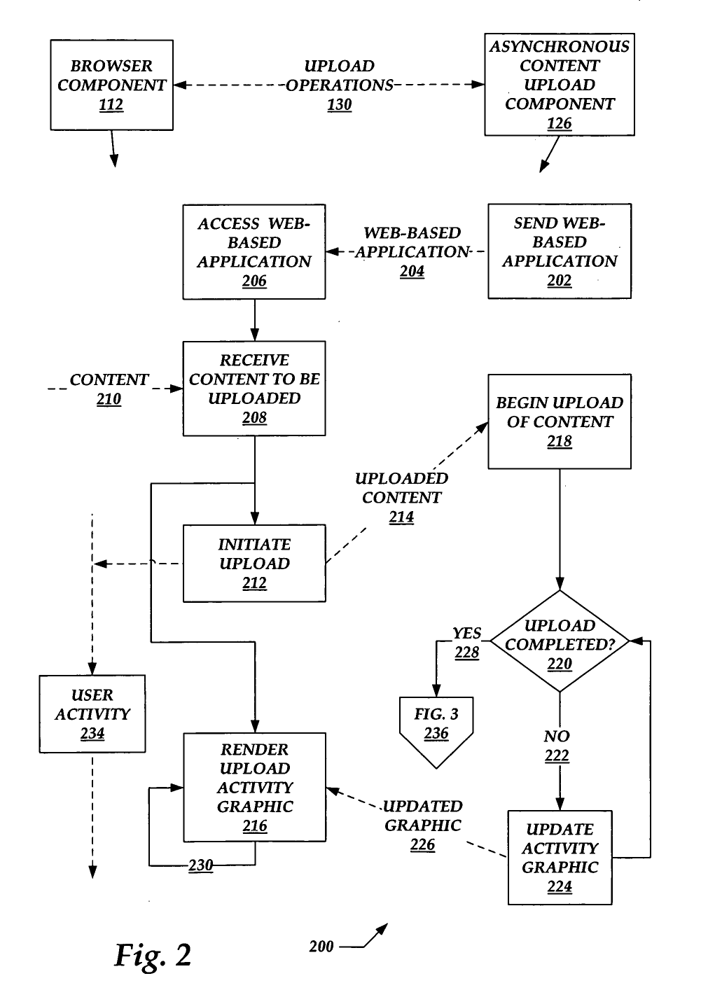

FIG. 2 illustrates processes, denoted generally at 200, for asynchronously uploading content to a server system. For ease of reference and description, but not to limit possible implementations, the processes 200 are described in connection with a browser component and a software component for asynchronously uploading content to one or more server systems (e.g., 116). FIG. 2 carries forward examples of such browser components and asynchronous upload components respectively at 112 and 126, along with examples of the upload operations at 130. However, it is further noted that the processes 200 may be implemented in connection with other components, without departing from the scope and spirit of the present description.

Turning to the processes 200 in more detail, block 202 represents sending code representing a web-based software application to one or more client systems. FIG. 2 generally represents this web-based software application at 204. Examples of such web-based software applications may include, but are not limited to, applications related to word processing or document editing, applications related to creating or editing spreadsheets, applications related to creating or managing databases, applications for creating or editing presentations, note-taking applications, and the like. Additional examples of these web-based software applications may include image or video editing applications.

In general, the web-based applications 204 may be executed within the browser components 112 on the client systems 104. Accordingly, block 206 represents accessing capabilities or functionality provided by the web-based applications. For example, block 206 may include accessing capabilities of the web-based application through the browser component 112.

Block 208 represents receiving content to be uploaded to the server systems 116, for eventual presentation within the browser components 112. FIG. 2 represents examples of the content at 210. For example only, and without limiting possible implementations, examples of the content 210 may include pictures, images, video, and other types of graphical or visual content. In some cases, these instances of graphical or visual content may be representations of physical objects. For example, block 208 may include receiving content (e.g., pictures, movies, images, or the like) from peripheral devices such as digital cameras, video/audio/voice recorders, music players, and the like. These devices may be coupled to communicate with the client system 104. In other examples, block 208 may include retrieving the content 210 as previously loaded into storage resources provided by the client systems 104.

In example implementation scenarios, a given user (e.g., 102) may interact with the browser component 112 to access the web-based application 204. More specifically, the user 102 may use the web-based application 204 to create and/or edit a given document, with this given document including one or more pictures provided by the user. Thus, these pictures may provide non-limiting examples of the content 210.

In some cases, browser security models may preclude the browser components 112 from accessing the resources of the client system 104. Accordingly, block 212 represents initiating a process by which the content 210 is uploaded from the client system 104 to the server system 116. More specifically, block 212 may include enabling the user 102 to interact with the browser component 112, to request that the content 210 be uploaded to the server systems 116. FIG. 2 generally represents the uploaded content at 214.

Block 216 represents rendering a placeholder element at the browser component 112. More specifically, block 216 may include rendering an upload activity graphic at the browser component 112, for presentation to the user while the upload continues between the client system 104 and the server system 116.

At the server system 116, block 218 represents beginning the upload of a given instance of content by the asynchronous upload components 126. In providing this description, however, it is noted that a given instance of the asynchronous upload component 126 may be involved with uploading any number of different instances of uploaded content 214 from any number of different client systems 104.

In some implementations, the upload activity graphic rendered on the browser component 112 may be a static or unchanging icon that indicates that an upload is underway between the client system 104 and the server system 116. In other implementations, however, the upload activity graphic may provide a dynamic update on the status of an ongoing upload involving a given client system 104. For example, if the uploaded content 214 is an image or picture, some image or picture formats may include any header at the beginning of the image or picture file. This header may indicate the approximate dimensions of the image or picture. These dimensions may be expressed as numbers of pixels with respect to a two-dimensional (2-D) coordinate system. For example, a given image may include X pixels along one axis, and Y pixels along another axis.

Given this dimension information, whether obtained from a header or otherwise, the asynchronous upload component 126 may estimate how much of the content 214 has been uploaded at a given time. As the upload to the server system 116 progresses, this percentage of completion may be updated, as now described in further detail.

Decision block 220 represents evaluating whether a given upload from a given client system 104 has completed. So long as that given upload is not completed, the process flows 200 may take No branch 222 to block 224. In implementations that estimate a time to completion for the upload, block 224 represents updating the upload activity graphic as appropriate to reflect a status of the upload at a given time. In such implementations, block 224 may also include sending the updated status (e.g., percentage completed, or estimated time to completion) to the browser component 112, as represented generally at 226. Afterwards, the process flows 200 may return to block 220 to evaluate whether the given upload is completed. As the upload proceeds, the process flows 200 may take No branch 222 at some suitable interval to update and send the activity graphic (e.g., 226) for display in the browser component 112.

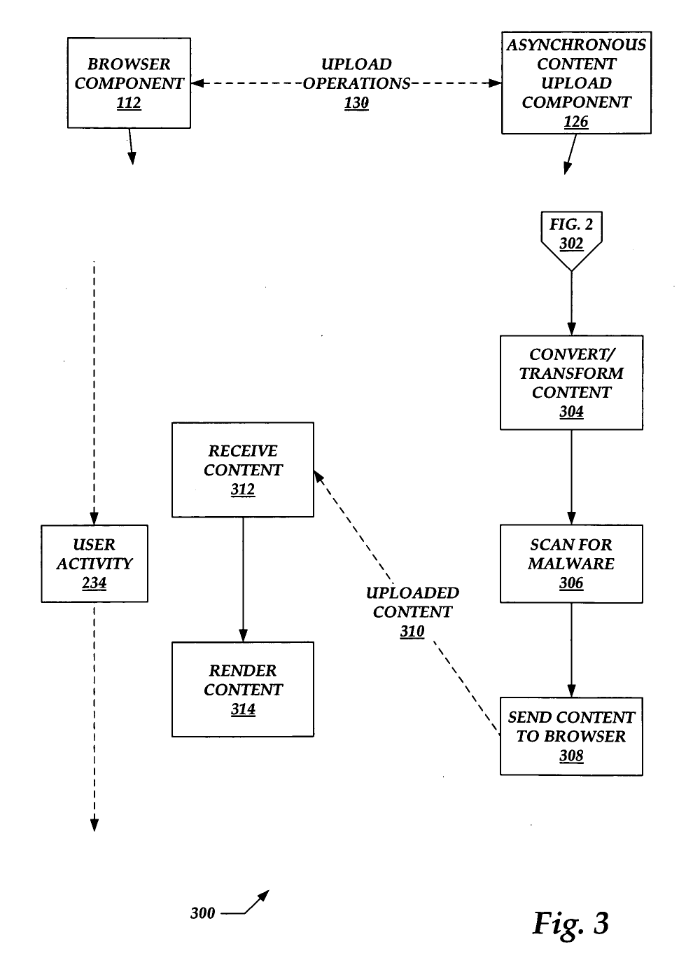

Returning to decision block 220, once an upload to a given client system 104 has completed, the process flows 200 may take Yes branch 228 to perform certain process flows described in connection with FIG. 3 below. Portions of the process flows 200 are shown in FIG. 3 only for clarity of illustration, but not to limit possible implementations of this description.

Turning to the browser component 112, block 216 may also include receiving and rendering the updated activity graphics 226 within the browser component 112. As described above, in some implementations, the upload activity graphics may include relatively static icons or animations that do not reflect status of a current upload. However, these examples of the upload activity graphics may be animated to provide some level of visual feedback to the users 102. In other implementations, the upload activity graphics may be more dynamic in nature, to indicate how much of a given upload is completed at a given time. FIG. 2 represents either of these scenarios by the arrow 230, which loops at block 216 to represent receiving any number of updated upload activity graphics 226.

The overall process flows 200 may include enabling user activities 234 to occur in parallel with the content upload 214. Examples of the user activities 234 may include edits, formatting, or other actions or interactions occurring between the users 102 and the web-based application 204. For example, once a given upload of content is initiated at block 212, this upload process may occur as in the background between the browser component 112 and the asynchronous upload component 126. In this manner, the browser component 112 may enable the users 102 to perform any number of the user activities 234 while the upload process is ongoing. In such implementations, the ongoing upload process does not interrupt or suspend the user activities 234. Accordingly, the process flows 200 may enable the users 102 better to utilize the web-based application 204 through the browser component 112, without being impeded by the ongoing content upload 214. Put differently, the ongoing user activities 234 may proceed asynchronously and in parallel with any number of ongoing content uploads 214.

Having provided the above description of FIG. 2, the discussion now proceeds to a description of FIG. 3. For ease of reference, but not to limit possible implementations, the process flows as shown in FIGS. 2 and 3 may connect via off-page reference 236.

FIG. 3 illustrates process flows, denoted generally at 300, that continue the illustration of the asynchronous uploading processes shown in FIG. 2. As discussed above with FIG. 2, FIG. 3 carries forward an example component 126 for asynchronously uploading content from a browser component 112, as represented generally by upload operations 130.

Turning to the process flows 300 in more detail, the description of FIG. 3 begins at the off-page reference 302, which corresponds to the off-page reference 236 shown in FIG. 2. Recalling previous description, the process flows 200 shown in FIG. 2 may perform the processing shown in FIG. 3 once a given instance of content is completely uploaded to the server system 116.

Block 304 represents converting or transforming the uploaded content into a format suitable for rendering any browser component 112. Returning to the above example pertaining to image or picture files uploaded to the server system 116, different instances of these image or picture files may comply with any number of different file formats. However, the browser components 112 may or may not be able to process these different formats. Accordingly, the asynchronous upload components 126 may convert the uploaded contents into file formats that are most likely to be compatible with the browser components 112. It is noted, however, that the above examples pertaining to image or picture files may be generalized to other types of content, without departing from the scope and spirit of the present description.

Block 306 represents scanning or analyzing the uploaded content for infection by viruses or the like (denoted collectively as “malware”). In some cases, if uploaded content affected by such malware is rendered on the browser components 112, the hosting client systems 104 may become infected. However, certain implementations of the asynchronous upload component 126 may help to contain the spread of such malware through the content (e.g., 214 in FIG. 2) uploaded to the server system 116.

Block 308 represents sending the content as uploaded to the server system 116 for rendering on the browser component 112. FIG. 3 denotes at 310 the uploaded content as sent for rendering on the browser component 112.

Turning to the browser component 112, block 312 represents receiving the uploaded content 310, and block 314 represents rendering the content within the browser component 112. More specifically, block 314 may include rendering the uploaded content 310 in place of the placeholder sent previously by the asynchronous upload component 126 when the upload began. FIG. 2 provides the upload activity graphic as non-limiting example of such a placeholder.

FIG. 3 also carries forward the example user activities 234, and illustrates how any number of these user activities 234 may occur in parallel with the processing represented in blocks 312 and 314. For example, as described in further detail below in connection with example user interfaces suitable for asynchronously uploading and resizing content in web-based applications, a given user 102 may be editing text or otherwise using the web-based application 204 while the browser component receives and renders the uploaded content 310 from the server system 116.

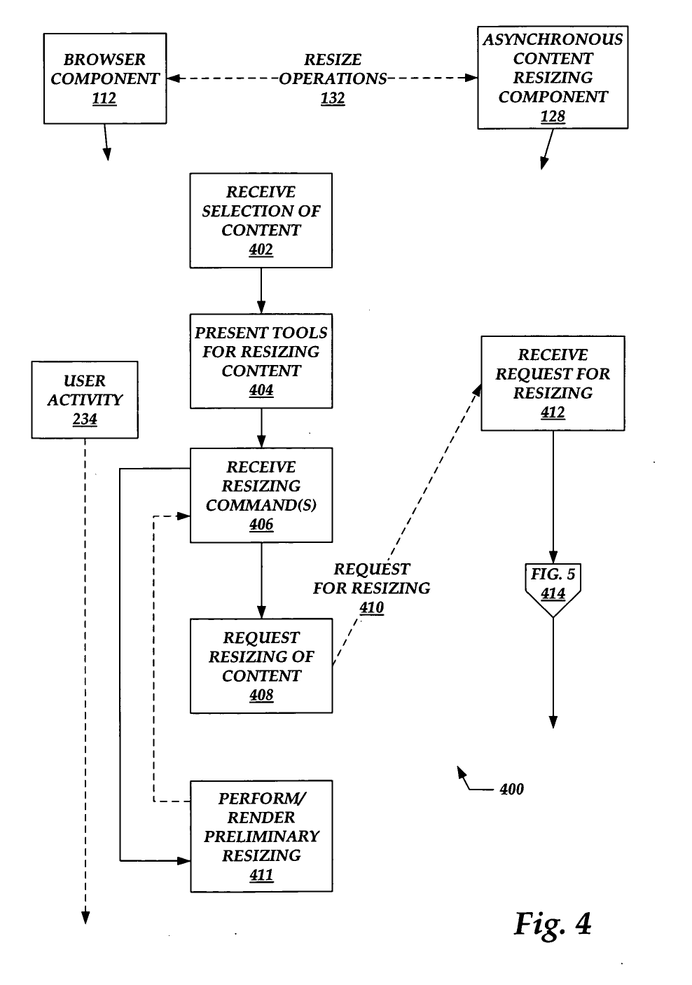

FIG. 4 illustrates processes, denoted generally at 400, for asynchronously resizing content uploaded to a server system. For ease of reference, but not to limit possible implementations, FIG. 4 carries forward from FIG. 1 an example browser component 112 and an example component 128 for asynchronously resizing content presented within the browser component 112. These resize operations are represented generally at 132.

Before proceeding with a more detailed description of the processes 400, it is noted that in some implementations of this description, the processes 400 may resize content uploaded and rendered in the browser component 112 using the techniques shown in FIGS. 2 and 3. However, in other implementations, the processes 400 may resize content rendered in the browser component 112 without using the techniques shown in FIGS. 2 and 3.

Turning to the processes 400 in more detail, more specifically to the browser component 112, block 402 represents receiving an indication that a user (e.g., 102 in FIG. 1) has selected particular content within the browser component 112. For example, block 402 may include receiving an indication that the user has selected some type of visual or graphic content rendered within the browser component 112. Examples of such visual or graphic content may include, but are not limited to, images, pictures, video clips, textual subject matter presented as images or bitmaps, and the like.

Block 404 represents presenting one or more devices or tools suitable for resizing the content selected in block 402. For example, block 404 may include presenting a user interface (UI) that incorporates such devices or tools for resizing the selected content.

Block 406 represents receiving one or more resizing commands provided by the user through the devices or tools presented in block 404. As illustrated and discussed below, these resizing tools may enable the user to request that the selected content be enlarged or shrunk, as appropriate in different implementation scenarios.

Block 408 represents requesting that the content selected in block 402 be resized according to the resizing commands received in block 406. Typically, the browser component 112 has limited functionality. Accordingly, block 408 may include sending one or more resizing requests 410 to the server subsystem 116 (as shown in FIG. 1). More specifically, block 408 may include sending the resizing requests 410 to the software components 128 for asynchronously resizing a selected content as rendered in the browser component 112. For example, the resizing requests 410 may indicate the content selected within the browser 112, and may also indicate a resizing factor (whether expressed as an enlargement or a reduction) to be applied to the selected content.

Block 411 represents performing a preliminary resizing of the content on the browser component 112. For example, block 411 may include applying the indicated scale factor to the content, but without completely reprocessing the content. For example, considering implementations in which the resizing request 410 relates to expanding an image, block 411 may include expanding the image by applying the scale factor, but without yet reprocessing the individual pixels that constitute the image. Accordingly, block 411 may include generating a preliminarily resized image that may not be of optimum visual quality, but may nevertheless indicate the approximate dimensions or footprint of the resized image. In some implementations, block 411 may proceed in parallel with block 408, and in parallel with the processing performed on the resizing component 128 in response to the request 410.

In the foregoing manner, the resize operations 132 as performed by the browser component 112 and the resizing component 128 may enable users to visualize preliminary results of the requested resize operation. If the preliminarily resized content indicates unexpected results, blocks 406 and 411 may be repeated as appropriate to achieve the expected results, as indicated by the dashed arrow that connects block 411 to block 406.

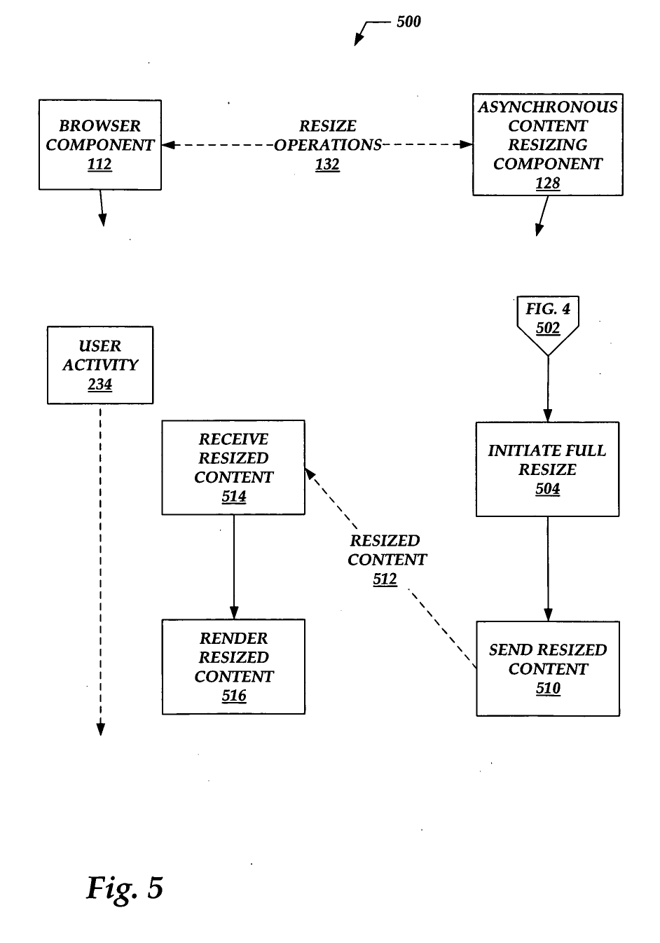

At the resizing component 128, block 412 represents receiving the resizing request 410. In response to this resizing request 410, the resizing component 128 may begin a set of operations discussed in further detail below with FIG. 5. For clarity of illustration, but not to limit possible implementations of this description, the operations shown in FIGS. 4 and 5 may be linked by an off-page reference 414. Accordingly, in some implementations, portions of the processing shown in FIGS. 4 and 5 may proceed asynchronously and in parallel with one another.

As described above, web-based applications may be deployed within the browser component 112. Non-limiting examples of these web-based applications are provided above. The browser component 112 may enable users (e.g., 102 in FIG. 1) to perform any number of activities or operations, carried forward at 234, asynchronously and in parallel with the resizing operations represented in FIGS. 4 and 5. Accordingly, the resizing operations performed in FIGS. 4 and 5 do not suspend or interrupt the user operations 234. More specifically, the users 102 may access the capabilities of the web-based applications deployed to the browser components 112 while the resizing operations are underway.

FIG. 5 illustrates process flows, denoted generally at 500, performed as part of the asynchronous resizing processes 400 shown in FIG. 4. More specifically, as indicated in the description of FIG. 4, at least portions of the process flows 500 may occur in parallel with at least portions of the process flows 400. For ease of reference, but not to limit possible implementations of this description, FIG. 5 carries forward from previous Figures representations of the browser component 112, the resizing component 128, and the resize operations 132.

As described above with FIG. 4, the process flows 400 may reach the process flows 500 by the off-page reference 414. Accordingly, the description of the process flows 500 in FIG. 5 begins with the off-page reference 502, which is linked to the off-page reference 414.

Turning to the process flows 500 in more detail, block 504 represents instantiating a full resize operation in response to the request 410 for resizing. As distinguished from the preliminary resizing performed in block 416, the full resizing performed in block 504 may include reprocessing the individual pixels of the resized content, to achieve visual quality that is similar to that of the content before resizing. For example, in instances where the resized content is an image, expanding this image without reprocessing the individual pixels may result in reduced image quality (e.g., a “grainy”, low resolution image). However, the reprocessing performed in block 504 may restore visual quality to the resized content, whether by reprocessing the pixels of expanded content, or by resampling the pixels of reduced content.

Block 510 represents sending the fully-resized image to the browser component 112 for rendering within the context of a web-based application deployed through the browser. FIG. 5 provides an example of the fully-resized or fully-reprocessed content at 512.

Referring to the browser component 112, block 514 represents receiving the fully-resized content 512. As described elsewhere herein, examples of the fully-resized content may include a reprocessed image or picture, video clip, bitmap, or the like.

Block 516 represents rendering the resized or reprocessed content 512 within the browser component 112. For example, block 516 may include rendering the resized content within the context of a web-based application deployed through the browser.

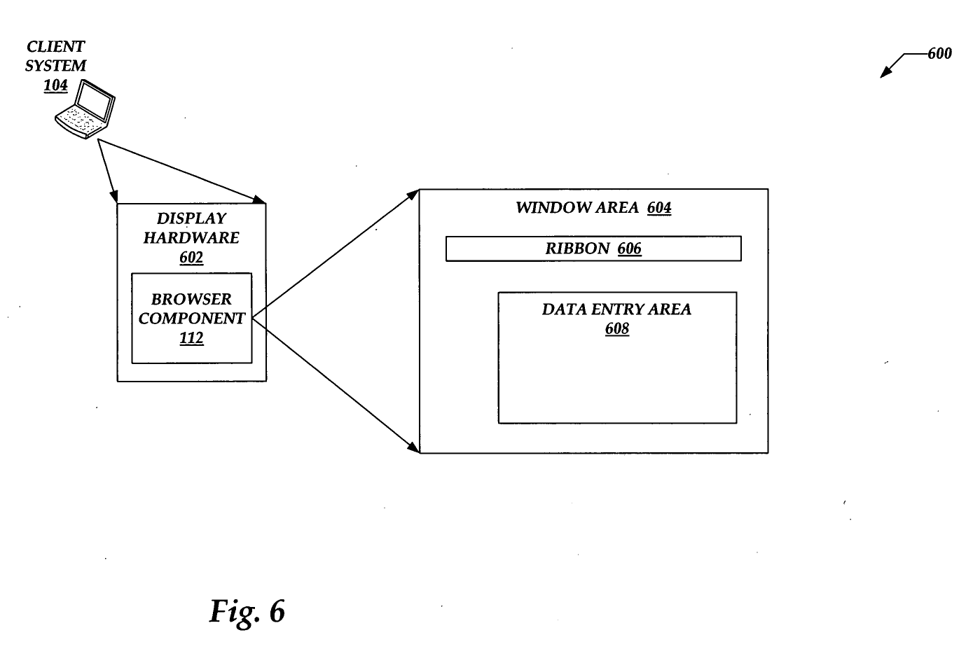

Having described the process flows in FIGS. 2-5, the discussion now proceeds to a description of several example user interfaces (UIs) that illustrate additional features of the tools and techniques for asynchronously uploading and resizing content in web-based applications. These UIs are illustrated and described in connection with FIGS. 6-14.

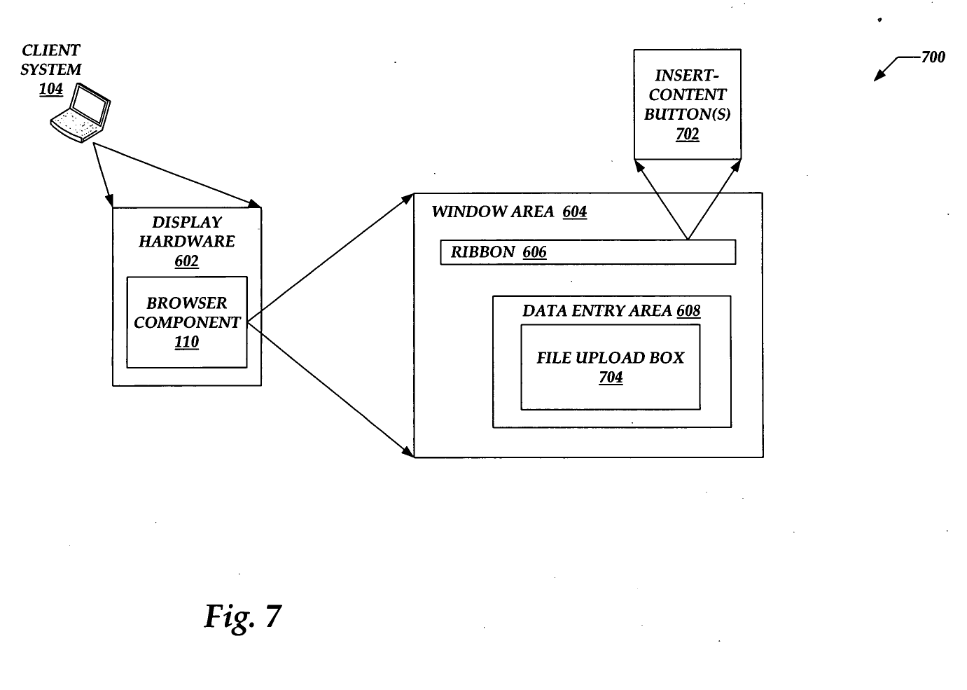

FIG. 6 illustrates example UIs, denoted generally at 600, suitable for uploading content from a client system to a server system. As shown, FIG. 6 carries forward an example client system 104, which may include suitable display hardware 602 for presenting the UI 600, as well as the other UIs discussed in connection with FIGS. 7-14. More specifically, the display hardware 602 may present a browser component (e.g., 112 carried forward from FIG. 1), through which one or more server systems (e.g. 116 in FIG. 1) may deploy web-based application to the client systems 104.

Turning to the UIs 600 in more detail, as presented within the browser component 112, these UIs 600 may include an overall window area 604, with this window area presented within some portion of the browser component 112. Within this window area 604, the UIs 600 may include any number of buttons, tools, or other devices. In some implementations, these buttons, tools, or other devices may be configured in a linear arrangement, whether horizontally or vertically. Accordingly, FIG. 6 illustrates one or more ribbons 606 represent these linear arrangements of buttons, tools, or other UI devices. Considered individually, these buttons, tools, or devices may be responsive to user input to perform requested operations. In some cases, the window area 604 may include a plurality of different ribbons 606, with different ribbons 606 containing buttons that are organized to perform particular categories of functions.

The window area may also include a data entry area 608, into which the web-based application is deployed through the browser component 112. For example, considering an example in which the web-based application is a word processing or document editing application, the data entry area 608 may represent that portion of the window area 604 into which the user may type or enter text, insert images or other objects, or otherwise enter content into the application. In general, the UIs 600 as shown in FIG. 6 are presented in an initial or preliminary state.

FIG. 7 illustrates additional features, denoted generally at 700, of the UIs as shown in FIG. 6, namely UI tools to present a selection of files available for uploading. For ease of reference, FIG. 4 carries forward the client system 104, the display hardware 602, and the browser component 112. In addition, FIG. 7 carries forward from FIG. 6 in the UI window area 604, the ribbons 606, and the data entry area 608.

The UIs 700 are described with reference to the above example in which a given user (e.g., 102 in FIG. 1) is editing a document using a web-based word processing application. At some point, that user may wish to insert some type of graphic or visual content into the document. Accordingly, the user may click or otherwise activate an appropriate button or tool within the ribbon 606, to invoke the tools described herein for asynchronously uploading content for insertion into the document. FIG. 7 illustrates, without limitation, an example button 702 that is responsive to user activation to initiate processes for asynchronously uploading content for insertion into the document. FIG. 1 illustrates software components 126 for asynchronously uploading content to the server systems 116, for insertion into the browser components 112, with the button 702 responsive to user input to activate the software components 126.

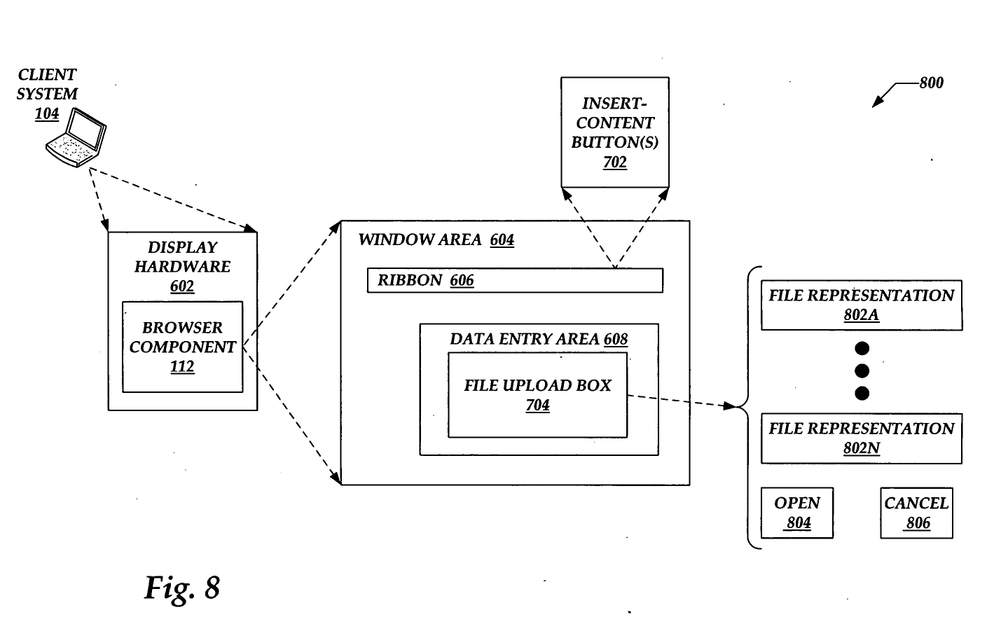

In response to activation of a button 702, the window area 604 may present a file upload box 704 within the data entry area 608. By interacting with the file upload box 704, the user 102 may navigate or browse to a particular file location within a directory structure, and may select particular content for uploading and insertion into the data entry area 608. For example, the file upload box 704 may enable the user to select one or more pictures or images for insertion into a given document being edited with the web-based word processing application. Additional features of the file upload box 704 are now described in connection with FIG. 8.

FIG. 8 illustrates additional features of the UIs, denoted generally at 800, namely UI tools to select one or more available files detaining content for uploading and insertion into the browser component 112. More specifically, FIG. 8 elaborates further on the file upload box 704 shown in FIG. 7.

Referring to FIG. 8 in more detail, the file upload box 704 may include any number of representations 802a and 802n of files or documents (collectively, file representations 802) within a given directory location to which the user has navigated. These file representations 802 may be responsive to activation by the user (e.g., clicking or other actions), so as to select one or more files containing content to be inserted into the data entry area 608.

In addition, the file upload box 704 may include a button 804 that is responsive to user activation to open any file representations 802 that are in a “selected” state when the user activates the open button 804. When the user issues commands to open one or more selected files, the asynchronous upload components 126 may initiate the process of uploading the selected files to the server system 116 for eventual insertion into the data entry area 608. The file upload box 704 may also include a cancel button 806 that is responsive to user activation to dismiss the file upload box 704.

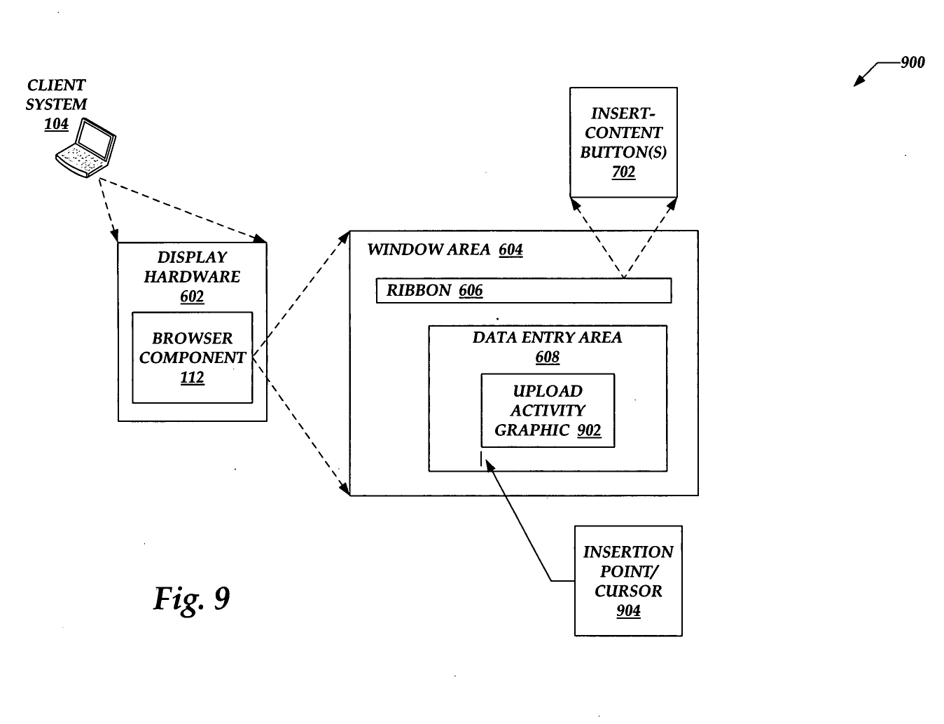

FIG. 9 illustrates additional features, denoted generally at 900, of the UIs as shown in FIG. 6. More specifically, FIG. 9 illustrates an upload activity graphic 902 that serves as a placeholder, presented with an insertion point or cursor 904 within the data entry area 608.

Once the user has selected one or more given files for asynchronous uploading and insertion into the data entry area, the asynchronous upload components 126 may initiate the processes shown above in FIGS. 2-3. Accordingly, once these processes are underway, the data entry area 608 may include the upload activity graphic 902.

In some implementations, the upload activity graphic 902 may be sized to indicate the approximate dimensions of the content selected above using the file upload box 704. For example, if the selected content is a picture or image file, the dimensions of the upload activity graphic 902 may approximate the dimensions of the selected picture or image. As described above, some formats of picture or image files may indicate the dimensions of the picture or image in a file header. However, implementations of this description may use any suitable technique for determining or estimating the dimensions of content represented within a given file.

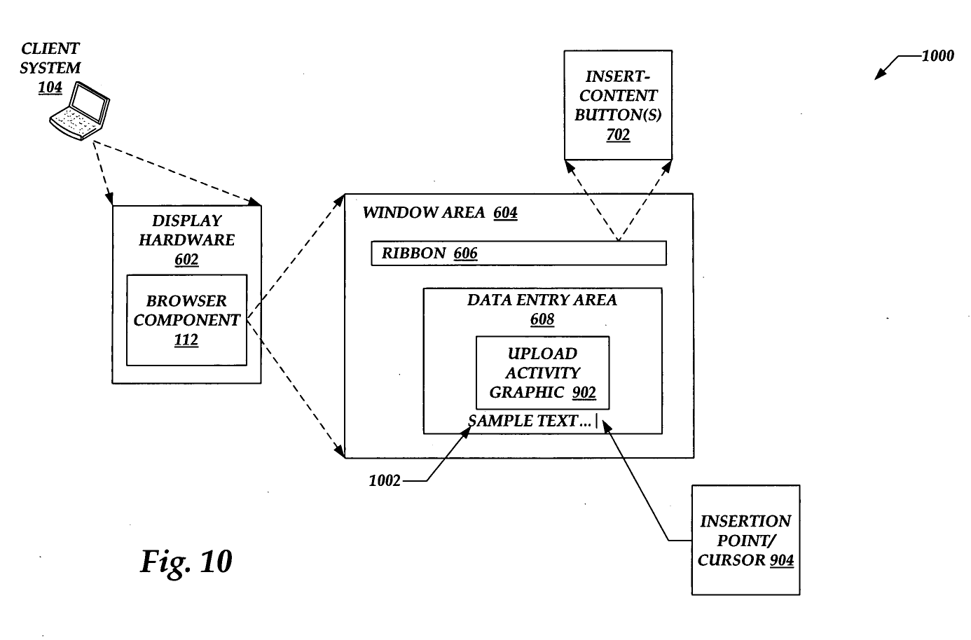

FIG. 10 illustrates additional features, denoted generally at 1000, of the UIs as shown in FIG. 6. More specifically, FIG. 10 illustrates sample text 1002 presented with the upload activity graphic 902. More specifically, the user may enter the sample text 1002 where indicated within the data entry area 608 by the insertion point or cursor 904. Accordingly, in implementations in which the upload activity graphic 902 approximates the dimensions of the selected content, the user may continue to edit within the data entry area 608. For example, the user may place the insertion point or cursor 904 somewhere within the data entry area 608, and begin entering text or other information 1002 around the upload activity graphic 902.

As shown in FIGS. 9 and 10, the data entry area 608 may enable the user 102 to visualize where the selected graphic content will appear once the server system 116 fully uploads the graphic content and inserts it into the browser component 112. In addition, the data entry area may enable the user 102 to work asynchronously and in parallel with the upload processes, entering text or other information while the upload processes are working in the background to insert the selected graphic content.

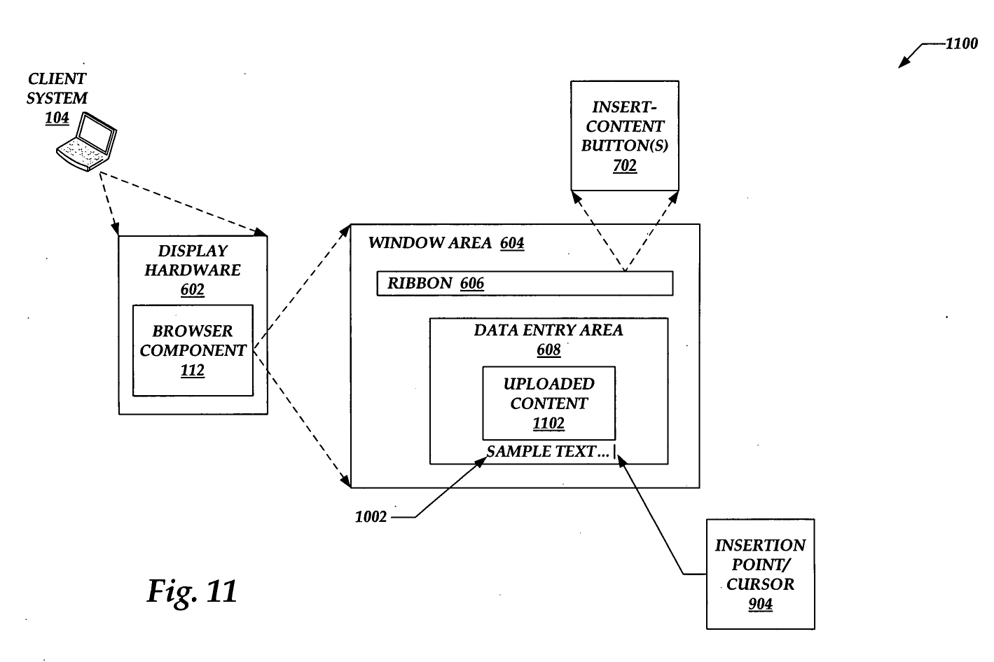

FIG. 11 illustrates additional features, denoted generally at 1100, of the UIs as shown in FIG. 6. More specifically, FIG. 11 illustrates uploaded content 1102, which replaces the upload activity graphic 902 shown as a placeholder in FIGS. 9-10 while the selected content is uploaded to the server system 116. However, once the server system has uploaded the selected content, and performed any appropriate post-upload processing, the server system 116 may insert the uploaded content 1102 into the data entry area 608. At this point, the uploaded content 1102 may be rendered within the context of any other information (e.g., sample text 1002) that the user entered into the data entry area 608 while the content was uploading.

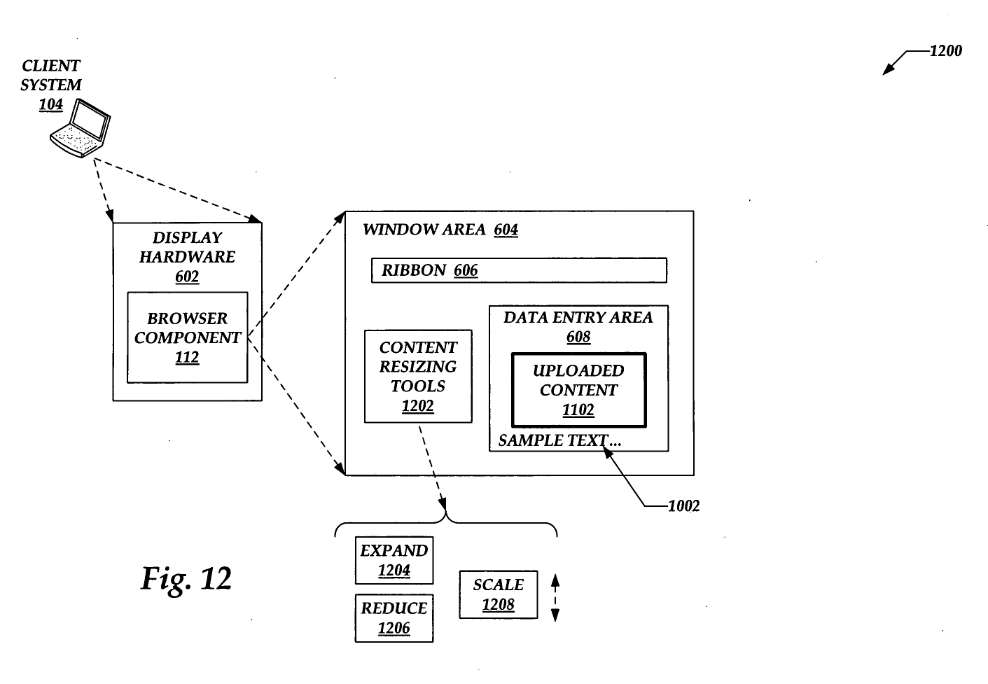

FIG. 12 illustrates additional features, denoted generally at 1200, of the UIs as shown in FIG. 6. More specifically, FIG. 12 illustrates uploaded graphical or visual content as activated or selected by a given user for resizing, along with a set of content resizing tools. For ease of reference and description, but not to limit possible implementations, FIG. 12 carries forward an example of uploaded content 1102 from FIG. 11. However, it is noted that the tools and techniques described herein for asynchronously resizing content may operate independently of the tools described above for asynchronously uploading content. Put differently, the uploaded content 1102 as shown in FIG. 12 may or may not be uploaded using the asynchronous uploading tools (e.g., 126 in FIG. 1).

Once the data entry area 608 contains some type of visual or graphic uploaded content 1102, a given user (e.g., 102 in FIG. 1) may activate or select this uploaded content 1102 for resizing. For example, the user may click or perform other selection actions within the dimensions represented by block 1102 in FIG. 12. In addition, the heavy border around the block 1102 shown in FIG. 12 indicates that the uploaded content is in a selected or activated state.

Once the uploaded content 1102 has been selected or activated for resizing, the window area 604 may present a set of content resizing tools 1202. In general, these content resizing tools 1202 may be responsive to user input to change the dimensions of the selected uploaded content 1102. For example, the content resizing tools 1202 may include a tool 1204 that is responsive to user input to expand or grow the dimensions of the selected uploaded content 1102 by a predefined amount. The user may repeatedly activate the tool 1204 to expand or grow the selected uploaded content 1102 by that predefined amount.

The content resizing tools 1202 may also include a tool 1206 that is responsive to user input to reduce or shrink the dimensions of the selected uploaded content 1102 by a predefined amount. The user may repeatedly activate the tool 1206 to reduce or shrink the selected uploaded content 1102 by that predefined amount.

The content resizing tools 1202 may also include a scaling tool 1208 that is responsive to user input to apply a scale factor (whether positive or negative) to the selected uploaded content 1102. For example, if a given user wishes to double the size of the selected uploaded content 1102, the user may enter “200%” into the scaling tool 1208. If the given user wishes to reduce the size of the selected uploaded content 1102 by half, the user may enter “50%” into the scaling tool 1208.

The content resizing tools 1202 may also include capabilities to manipulate graphical representations of the uploaded content 1102 to achieve a particular resizing. For example, a given user may click and hold some portion of the edge or the corner of the uploaded content 1102, and drag that portion of the uploaded content 1102 as appropriate to achieve a desired size. These resizing techniques may be referred to as “click and drag” techniques.

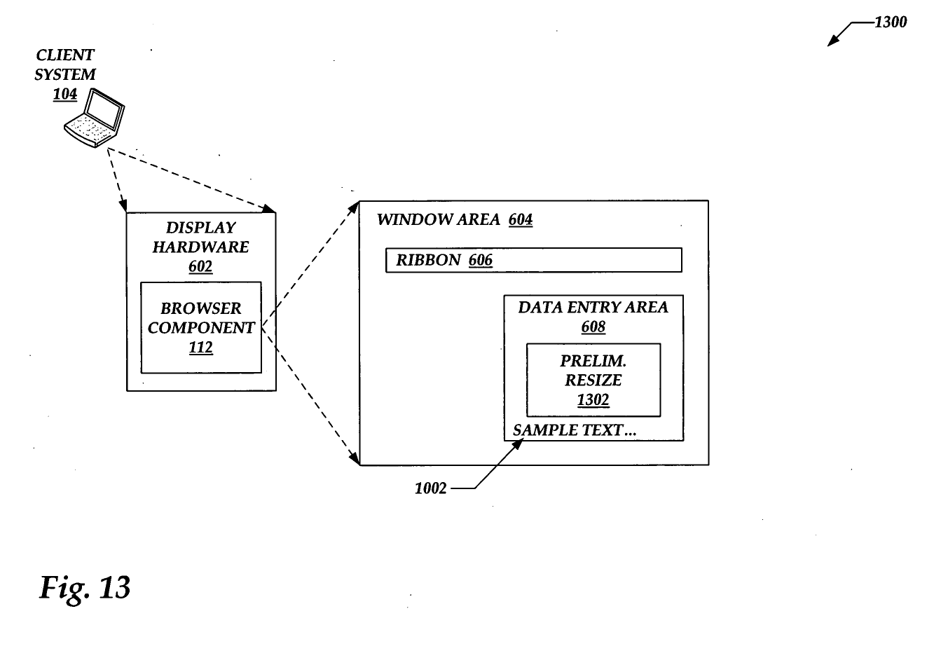

FIG. 13 illustrates additional features, denoted generally at 1300, of the UIs as shown in FIG. 6. More specifically, FIG. 13 illustrates the uploaded content as resized preliminarily, in response to a content resizing command issued using the content resizing tools 1202 shown in FIG. 12. FIG. 13 denotes at 1302 the preliminarily resized content. As described above, in cases where the selected content is expanded, the preliminarily resized content 1302 may reflect the overall dimensions of the expanded content. However, until the resized content 1302 is reprocessed by the server system 116, the visual quality may be reduced. However, the preliminarily resized content 1302 may nevertheless enable the user to visualize the new dimensions of the resized content, and may enable the user to enter sample text 1002 around the resized content 1302.

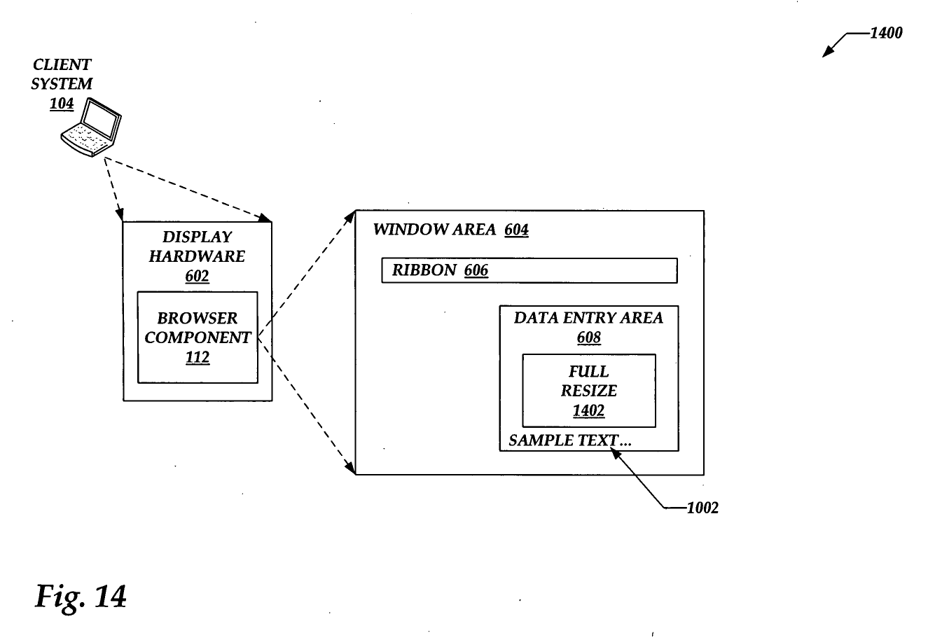

FIG. 14 illustrates additional features, denoted generally at 1400, of the UIs as shown in FIG. 6. More specifically, FIG. 14 illustrates the preliminarily resized content 1302 and FIG. 13 as completely reprocessed, in response to the content resizing command. FIG. 14 denotes the fully resized and fully reprocessed content at 1402, presented in the context of sample text 1002 inside the data entry area 608.

The foregoing description provides technologies for asynchronously uploading and resizing content in web-based applications. Although this description incorporates language specific to computer structural features, methodological acts, and computer readable media, the scope of the appended claims is not necessarily limited to the specific features, acts, or media described herein. Rather, this description provides illustrative, rather than limiting, implementations. Moreover, these implementations may modify and change various aspects of this description without departing from the true spirit and scope of this description, which is set forth in the following claims.

1. Apparatus comprising at least one computer-readable storage medium having stored thereon computer-executable instructions that, when loaded into a processor and executed, cause the processor to:
deploy at least one instance of a web-based application within a browser component on at least one client system, at least begin an upload of at least one instance of content from the client system, send an upload activity graphic for rendering within the browser component while the content is uploading from the client system, and to enable at least one user to interact with the client system while the content is uploaded; and to
receive at least one request to resize at least one instance of the content rendered within the browser component on the client system, cause the browser component to perform a preliminary resizing on the content, cause the browser component to render the preliminarily resized content, initiate a full resizing of the content, and to enable at least one user to interact with the client system during the full resizing of the content.

2. The apparatus of claim 1, further comprising instructions to update the upload activity graphic with a status indicating an estimated percentage of completion associated with the upload.

3. The apparatus of claim 1, further comprising instructions to complete the upload of the content from the client system, and further comprising instructions to send the content to the client system for rendering in the browser component.

4. The apparatus of claim 3, further comprising instructions to transform a state of the browser component to incorporate a visible representation of the content, wherein the content represents at least one physical object.

5. The apparatus of claim 1, further comprising instructions to scan at least a portion of the content for malware.

6. The apparatus of claim 1, further comprising instructions to convert the content from an originating format, which is not presentable in the browser component, into a destination format that is presentable in the browser component.

7. The apparatus of claim 1, wherein the instructions to enable at least one user to interact with the client system include instructions and enabling the user to perform at least one editing tasks through the browser component during the upload.

8. The apparatus of claim 1, further comprising instructions enabling the user to add further content during the upload, other than the content, using the web application in the browser component.

9. The apparatus of claim 1, wherein the instructions at least to begin an upload of at least one instance of content include instructions to begin an upload of an image, embedded file, audio, or video.

10. The apparatus of claim 1, further comprising instructions at least to begin an upload of at least a further instance of content from the client system.

11. The apparatus of claim 1, further comprising instructions to estimate dimensions of the content, and further comprising instructions to size the upload activity graphic to match the estimated dimensions of the content.

12. Apparatus comprising at least one computer-readable storage medium having stored thereon computer-executable instructions that, when loaded into a processor and executed, cause the processor to:
receive at least one request to resize at least one instance of content rendered within a browser component on a client system, wherein a web-based application is deployed onto the client system using the browser component;
cause the browser component to perform a preliminary resizing on the content;
cause the browser component to render the preliminarily resized content;
initiate a full resizing of the content; and
enable at least one user to interact with the client system during the full resizing of the content.

13. The apparatus of claim 12, further comprising instructions to complete the full resizing of the content, and further comprising instructions to send the fully resized content to the client system for rendering in the browser component.

14. The apparatus of claim 12, wherein the instructions to enable at least one user to interact with the client system include instructions to enable the user to add at least a further instance of content in the browser component during the full resizing.

15. The apparatus of claim 12, wherein the instructions to initiate a full resizing include instructions to initiate the full resizing without interrupting a workflow performed by the user and interacting with the web-based application.

16. The apparatus of claim 12, further comprising instructions to detect that the user has selected the content within the browser component, and in response, resending a least one user interface (UI) device in the browser component, wherein the UI device is responsive to user input to generate the request to resize the content.

17. The apparatus of claim 12, further comprising instructions to receive a further request to resize the content during the full resizing of the content, and further comprising instructions to receive a request to resize at least a further instance of content.

18. A system comprising:
at least one client subsystem that includes at least one processor that is coupled to communicate with at least a first computer-readable storage medium, wherein the first computer- readable storage medium includes at least a browser component;
at least one server subsystem that includes at least one processor coupled to communicate with at least a second computer-readable storage medium, wherein the second computer-readable storage medium includes an asynchronous upload component and at least an asynchronous content resizing component;
wherein the asynchronous upload component is operative to
deploy at least one instance of a web-based application within a browser component at the client system;
at least begin an upload of at least one instance of content from the client system;
send an upload activity graphic for rendering within the browser component while the content is uploading from the client system; and
enable at least one user to interact with the client system while the content is uploaded; and
wherein the asynchronous content resizing component is operative to
receive at least one request to resize at least one instance of the content rendered within the browser component on the client system;
cause the browser component to perform a preliminary resizing on the content;
cause the browser component to render the preliminarily resized content;
initiate a full resizing of the content; and
enable at least one user to interact with the client system during the full resizing of the content.

19. The system of claim 18, wherein the content is an image representing at least one physical object.

20. The system of claim 18, wherein the web-based application is a word processing application.
